(19) United States
(12) Patent Application Publication
(10) Pub. No.: US 2025/0050433 A1
(43) Pub. Date: Feb. 13, 2025

(54) TOOL BIT WITH WORK-HARDENING SECTION

(71) Applicant: QUANTUM IMPACT, LLC, Troy, MI (US)

(72) Inventors: J. Scott Myles, Bloomfield Township, MI (US); Randy Keller, Harper Woods, MI (US); Colin Kelly Myles, Waterford, MI (US); Gary Stade, Shelby Township, MI (US); J. Edgar Myles, West Bloomfield, MI (US)

(21) Appl. No.: 18/797,765

(22) Filed: Aug. 8, 2024

Related U.S. Application Data
(60) Provisional application No. 63/518,188, filed on Aug. 8, 2023.

(51) Int. Cl. B23B 51/08

(52) U.S. Cl. CPC B23B 51/08

(57) ABSTRACT

A tool bit includes a shaft that defines a bit axis and has a first end and a second end. There is at least one work-hardening section adjacent the second end. The at least one work-hardening section has a profile that either is cylindrical or is a portion of a sphere. The at least one work-hardening section defines a smooth working surface.

### BACKGROUND

When repetitively performing machining operations on a workpiece, such as drilling operations, it is generally desirable to perform those machining operations as quickly as possible. However, performing a machining operation too quickly can undesirably increase the thrust force and torque applied to a workpiece by a tool, potentially shortening tool life and detrimentally affecting the geometry and/or integrity of the feature desired on the workpiece. Additionally, subsequent operations are often required to finish and strengthen the drilled holes, which is costly and lengthens overall processing time.

### BRIEF DESCRIPTION OF THE DRAWINGS

FIG. 1 is a schematic view of a machining device and an associated positioning device.

FIG. 2 is a schematic view of the machining device of FIG. 1 in greater detail.

FIG. 3 schematically illustrates an example implementation of a linear motor and transition assembly for the machining device of FIG. 1.

FIG. 4A schematically illustrates an example implementation of a rotary motor for the machining device of FIG. 1.

FIG. 4B schematically illustrates a cross-sectional view of an example sleeve of the rotary motor of FIG. 4A.

FIG. 5 illustrates another example machining device.

FIG. 6 is a flowchart showing an example optimization mode for the machining device of FIG. 1.

FIG. 7 illustrates a graph demonstrating performance of an example frequency sweep during a machining operation.

FIG. 8 illustrates a graph showing how a thrust force applied by the machining device varies during the frequency sweep of FIG. 7.

FIG. 9 is a flowchart of an example run mode for the machining device of FIG. 1.

FIG. 10A illustrates an example single-layer workpiece.

FIG. 10B illustrates an example multi-layer workpiece.

FIG. 11 is a flowchart of an example adaptive run mode for the machining device of FIG. 1.

FIG. 12 is a flowchart showing an example optimization mode for optimizing a rotational velocity of the machining device of FIG. 1.

FIG. 13 illustrates an example drill bit tool.

FIG. 14 illustrates example work-hardening tool.

FIG. 15 illustrates another work-hardening tool.

FIG. 16 illustrates yet another work-hardening tool.

FIG. 17 illustrates a cross-sectional view of the example work-hardening tool of FIG. 14 adjacent a hole in a workpiece.

FIGS. 18A illustrates a cross-sectional view of the example work-hardening tool of FIG. 14 partially extended through the hole in the workpiece.

FIG. 18B illustrates a bottom view of the example work-hardening tool of FIG. 14 partially extended through the hole in the workpiece.

FIG. 19 illustrates a cross-sectional view of the example work-

hardening tool of FIG. 14 after extending entirely through the hole in the workpiece.

FIG. 20 illustrates a combined work-hardening tool.

FIG. 21 illustrates another combined work-hardening tool. FIG. 22 illustrates an example stress strain curve.

### SUMMARY

A tool bit according to an example of the present disclosure includes a shaft that defines a bit axis and has a first end and a second end. There is at least one work-hardening section adjacent the second end. The at least one work-hardening section has a profile that either is cylindrical or is a portion of a sphere. The at least one work-hardening section defines a smooth working surface.

In a further example, the tool bit is part of a machining device according to the present disclosure.

In a further example, the tool bit is used in a method according to the present disclosure.

The present disclosure may include any one or more of the individual features disclosed above and/or below alone or in any combination thereof.

### DETAILED DESCRIPTION

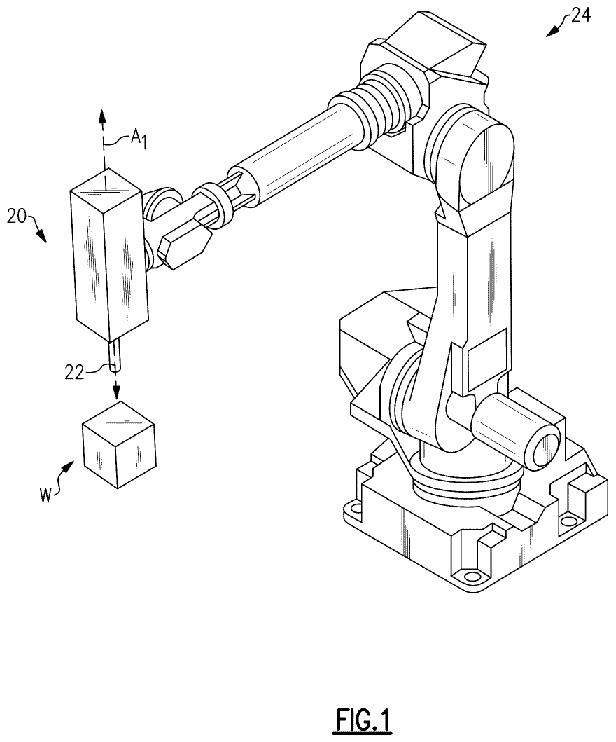

FIG. 1 is a schematic view of an electromagnetically-operated machining device 20 that is operable to perform a machining operation with a tool 22. A positioning device 24 is operable to position the machining device 20 relative to a workpiece W, and in particular a portion of the workpiece W that is to be machined. Once positioned, the machining device 20 can perform a machining operation on that portion of the workpiece W.

In one example, the positioning device 24 can be programmed to move the machining device 20 in six degrees of freedom. However, it should be appreciated that a six degree of freedom positioning system may not be necessary for some applications and as such, other positioning systems may be used.

During machining operations, the machining device 20 provides linear feed movement of the tool 22 along a feed axis A1 relative to the workpiece W while superimposing oscillation of the tool 22 onto the feed axis A1 onto the linear feed movement and providing rotation of the tool 22 relative to the workpiece. The rotation could be provided by rotating the tool 22 or rotating the workpiece W. By superimposing oscillation onto the linear feed movement, a thrust force applied by the tool 22 to the workpiece W can be reduced, thereby prolonging tool life, and also allowing use of faster feed velocities at a given force level than would otherwise be possible without the superimposed oscillation.

In one example, while the positioning device 24 is used to position the machining device 20 with respect to the workpiece, the positioning device 24 does not move relative to workpiece W and/or the machining device 20 during an actual machining operation because the machining device 20 itself provides for its own feed movement during machining operations.

The machining device 20 can be used to perform any of a plurality of different machining operations, such as drilling, milling, and turning. In a drilling operation, the tool 22 is rotated about axis A1 and is fed in a direction parallel to the axis A1 into the workpiece W to create a round hole. In a milling operation, the tool 22 is rotated about the axis A1 and fed in a direction perpendicular to the axis A1 into the workpiece W to cut a profile matching the tool 22. In a turning operation, the workpiece W is rotated and the tool 22 is fed either parallel or perpendicular to the rotating workpiece W to create a cylindrical product.

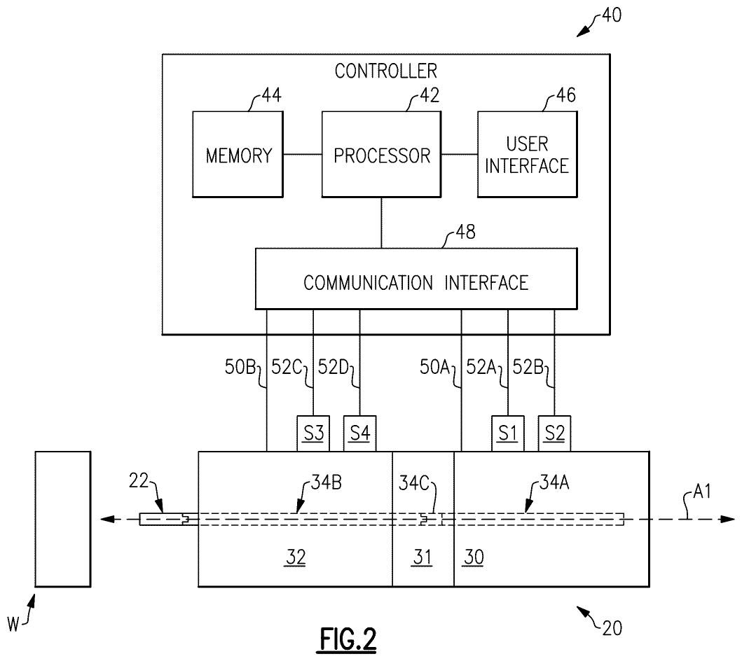

FIG. 2 is a schematic view of the machining device 20 device of FIG. 1 in greater detail. As shown in FIG. 2, the machining device 20 includes a linear motor 30, a transition assembly 31, and a rotary motor 32 that are each coupled to a shaft 34. The shaft 34 includes a first section 34A within the rotary motor 32 that provides linear movement along the feed axis A1 but does not rotate. The driveshaft 34 also includes a second section 34B within the rotary motor 32 that does rotate, and therefore acts as a drive shaft. The transition assembly 31 includes and intermediate section 34C that interconnects the two sections 34A-B.

The linear motor 30 is operable to provide linear movement of the tool 22 along the longitudinal axis A1 and is also operable to superimpose oscillation of the tool 22 onto the feed axis during the linear movement. The rotary motor 32 is operable to rotate the tool 22 about the longitudinal feed axis A1 during the linear feed movement. The linear motor 30 and rotary motor cooperate to perform a machining operation on the workpiece W.

A controller 40 is operable to control the linear motor 30 and rotary motor 32. The controller 40 includes a processor 42 that is operatively connected to memory 44, a user interface 46, and a communication interface 48. The processor 42 may include one or more microprocessors, microcontrollers, application specific integrated circuits (ASICs), or the like, for example. The memory 44, may include one or several types of memory such as read-only memory (ROM), random-access memory, cache memory, flash memory devices, optical storage devices, etc. The user interface 46 includes an input device and an electronic display, which may be combined in the form of a touch screen, for example.

The controller 40 utilizes communication interface 48 to provide control signals to the machining device 20 over control lines 50A-B and receive feedback from sensors S1-S4 over feedback lines 52A-D. The controller 40 is operable to cause the linear motor 30 to provide the linear movement and superimpose the oscillation by oscillating a direct current (DC) control signal provided to the linear motor 30 over control line 50A.

By oscillating the DC control signal provided to the linear motor 30, the controller causes the linear motor 30 to both provide linear movement of a tool 22 along the feed axis A1 relative to the workpiece W and superimpose oscillation of the tool 22 onto the feed axis A1 during the linear movement.

The sensors S1-S4 provide feedback about the operations of the linear motor 30 and rotary motor 32 to provide for closed loop feedback control. The sensors S1-S2 are operable to measure at least one machining parameter related to linear movement of the tool 22, and the sensors S3-S4 are operable to measure at least one machining parameter related to rotary movement of the tool 22.

In one example configuration, sensors S1 and S3 are displacement transducers, and sensor S2 and S4 are current sensors. This configuration is useful because measuring current applied to a stator of the linear motor 30 is one way to measure a thrust force applied by the linear motor 30, and measuring a current applied to a stator of the rotary motor 32 is one way to measure a torque force applied by the rotary motor 32. The stators are discussed below.

Some example types of linear displacement transducers that could be used for the sensor S1 include a linear encoder, linear variable differential transformer (LVDT), or magneto-restrictive device. Some example types of rotary displacement transducers that could be used for the sensor S3 include a rotary encoder, rotary differential transformer (RVDT), or resolver. Of course, it is understood that these are non-limiting examples and that others types of displacement sensors could be used.

In one example, by utilizing the sensors S1-S2, the controller 40 is able to determine any of the following and use any of the following as process variables for the linear motor 30 in a closed loop control: linear displacement and position, feed velocity, linear acceleration, current applied to linear motor 30, and thrust force.

In the same or another example, by utilizing the sensors S3-S4, the controller 40 is able to determine any of the following and use any of the following as process variables in a closed loop control for the rotary motor 32: revolutions per minute (RPM), rotational velocity, rotational acceleration, current applied to rotary motor 32, and torque.

Although the sensors S1-S4 are shown as being disposed at the machining device 20, it is understood that they could be disposed at other locations (e.g., measuring current at the controller 40 instead of at the machining device 20) and/or that other quantities of sensors could be used.

Although not shown in FIG. 2, the machining device 20 may include a tool holder for interchanging various tools 22 with the machining device 20 (e.g., a 3-jaw chuck, a collet, a drill arbor, or a taper spindle).

In the example of FIG. 2, the linear motor 30 and rotary motor 32 both surround the longitudinal axis A1.

FIG. 3 illustrates an example implementation of the linear motor 30 and transition assembly 31. As shown in the example of FIG. 3, the linear motor 30 includes a linear stator 60 that surrounds the feed axis A1. The linear stator 60 includes a radially inner portion 60A and a radially outer portion 60B which at least partially define an annular cavity 62 therebetween. A core 64 is moveable relative to the linear stator 60 from a position P1 to a position P2 to provide linear feed movement of the shaft 34 and the tool 22 coupled to the shaft 34.

The core 64 includes a hollow cylindrical portion 66 that is at least partially received into the cavity 62. FIG. 3 depicts the core 64 as being fully retracted, with the core 64 at position P1. Windings (not shown) surround portions of the core 64. As current is applied to windings, the core 64 moves linearly along the feed axis A1 towards position P2. A linear encoder 68 is provided to measure linear displacement of the core 64. Of course, as discussed above, other linear displacement transducers could be used. As the core 64 translates in the linear motor 30, the linear position of the core 64 can be determined as an incremental displacement value from a previous position or as an absolute position relative to a fixed datum.

In one example, an amplitude of the oscillation that is superimposed onto the feed movement is 0.0001″-0.0005″. In a further example, the amplitude of the oscillation that is superimposed onto the feed movement is 0.0001″-0.0003″. In either example, the amplitude of the oscillation is less than a distance between points P1 and P2 in FIG. 3. To provide for such precision, in one example the controller 40 has a resolution that is orders of magnitude greater than an amplitude of superimposed oscillation (e.g., if the amplitude is ±0.0002″, then the resolution could be anywhere between 10 to 1,000 times greater). This increased resolution enables fine-tuned adjustments for closed loop control of the machining device 20.

In one example, the intermediate shaft section 34C mounts to the shaft section 34B through a splined connection whereby a portion 37 of the shaft section 34B is received into a cavity 38 within the intermediate shaft section 34C. Bearings 36 support rotation of the shaft sections 34B-C.

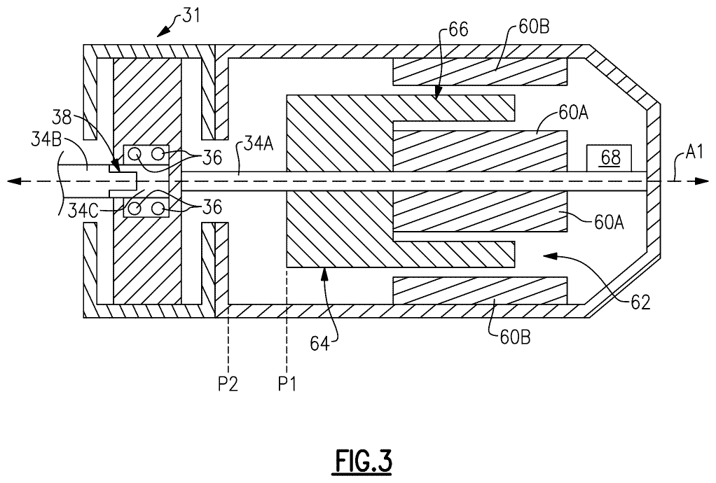

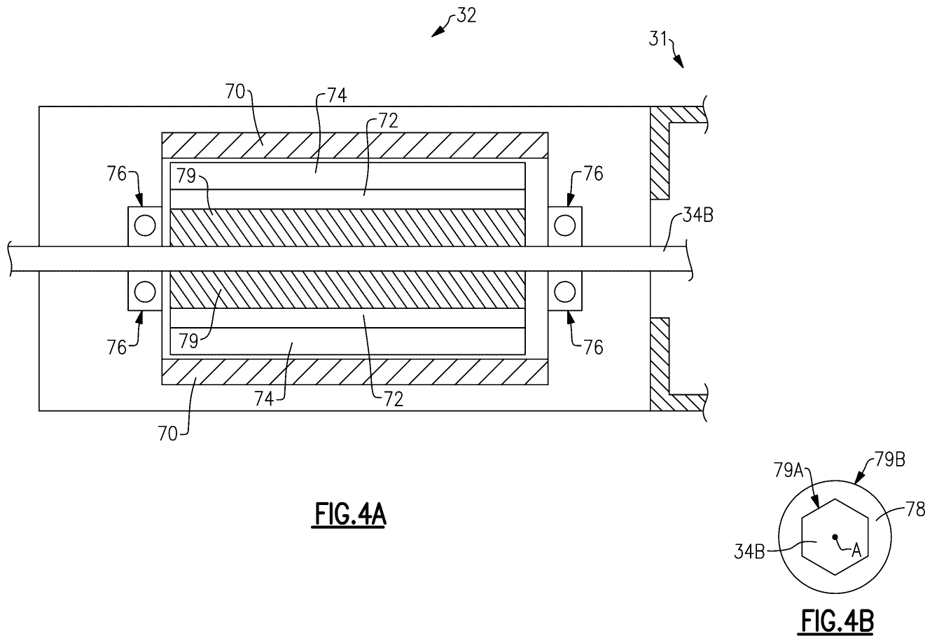

FIG. 4A illustrates an example implementation of the rotary motor 32, which includes a stator 70 and a rotor 72 that rotates relative to the stator 70. The stator 70 includes windings, and the rotor 72 includes a magnet assembly 74 that is coupled to the rotor 72 to rotate the rotor 72. Bearings 76 provide rotational support to the linear motor 30. As current is applied to the stator 70, rotation of the rotor 72 is provided. One of the sensor S3 or S4 (FIG. 2) measures rotary displacement of the shaft section 34B.

The rotary motor 32 includes a sleeve 78 having a radially outer surface 79B secured to the stator 70, and a radially inner surface 79A that engages the shaft section 34B and imparts rotation from the rotary motor 32 to the shaft section 34B and tool 22.

FIG. 4B schematically illustrates a cross-sectional view of the sleeve 78 and shaft 34. As shown in FIG. 4B, the shaft 34 has a non-circular shape that engages the radially inner surface 79A. Although FIG. 4B illustrates a hexagonal cross section for the shaft 34 and inner surface 79A, it is understood that other cross-sectional shapes could be used.

Those having ordinary skill in the art will appreciate that any electrical rotary motor including but not limited to AC and DC, synchronous and induction, brushed and brushless, and the like, known or later discovered and suitable for this purpose could be employed in place of the rotor 72 and stator 70 described above and that the device would still fall within the scope of the present disclosure.

In this disclosure, like reference numerals designate like elements where appropriate and reference numerals with the addition of one-hundred or multiples thereof designate modified elements that are understood to incorporate the same features and benefits of the corresponding elements.

FIG. 5 illustrates another example configuration for a machining device 120 in which linear motor 130 provides feed movement along longitudinal feed axis A1 and rotary motor 132 rotates about axis A2 which is parallel and spaced apart from axis A1. Components 160A-B, 164, and 168 associated with the linear motor 130 operate in a similar manner to their counterparts in FIG. 3. Each of the linear motor 130 and rotary motor 132 are coupled to a support housing 180 which has opposing first and second sides 181A-B. An internal cavity is provided between the opposing sides 181A-B. A shaft 134 is provided having a first section 134A that does not rotate and a second section 134B that does rotate. A transition assembly 131 interconnects the two shaft sections 134A-B with a splined connection between shaft section 134B and intermediate shaft section 134C, whereby a portion 137 of the shaft section 134B is received into a cavity 138 within the intermediate shaft section 134C.

A drive mechanism 183 within the internal cavity 182 translates rotation of a spindle 184 of the rotary motor 132 to rotation of the shaft 134. The drive mechanism 183 can include a belt and/or geared architecture, for example.

Although internal details for the rotary motor 132 are not shown, it is understood that they could be similar to or the same as that of the rotary motor 32.

Also, although the linear motor 30 and rotary motor 32 are primarily discussed below, it is understood that the methods and features described for the linear motor 30 and rotary motor 32 can also be applied to the linear motor 130 and rotary motor 132 unless otherwise specified.

The machining device 20/120 includes multiple operating modes, including an “optimization mode” and a “run mode.” During the optimization mode, the machining operation is performed on a first workpiece portion while providing the linear feed movement at an initial feed velocity V_{FM}, and sequentially superimposing the oscillating at a plurality of different frequencies. Also during the optimization mode, one of the plurality of different frequencies that causes the tool to apply less thrust force to the first workpiece portion at the initial feed velocity than others of the frequencies at the initial feed velocity (e.g., the one that applies the least thrust force) is determined to be an optimal oscillation frequency.

During the run mode, the machining operation is performed on a second workpiece portion which may have the same composition as the first workpiece portion, while superimposing the oscillation at the optimal oscillation frequency. The first workpiece portion and second workpiece portion can be part of a same workpiece or can be part of different workpieces.

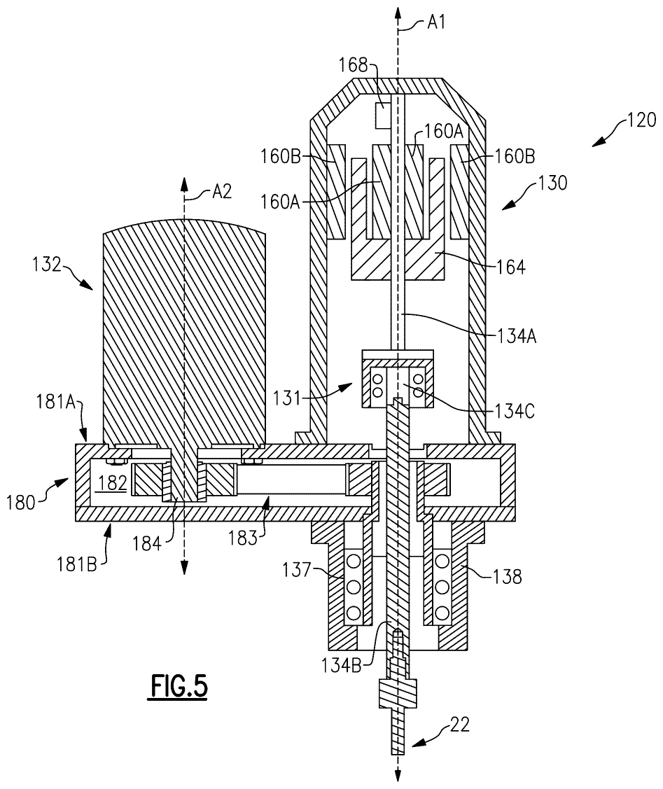

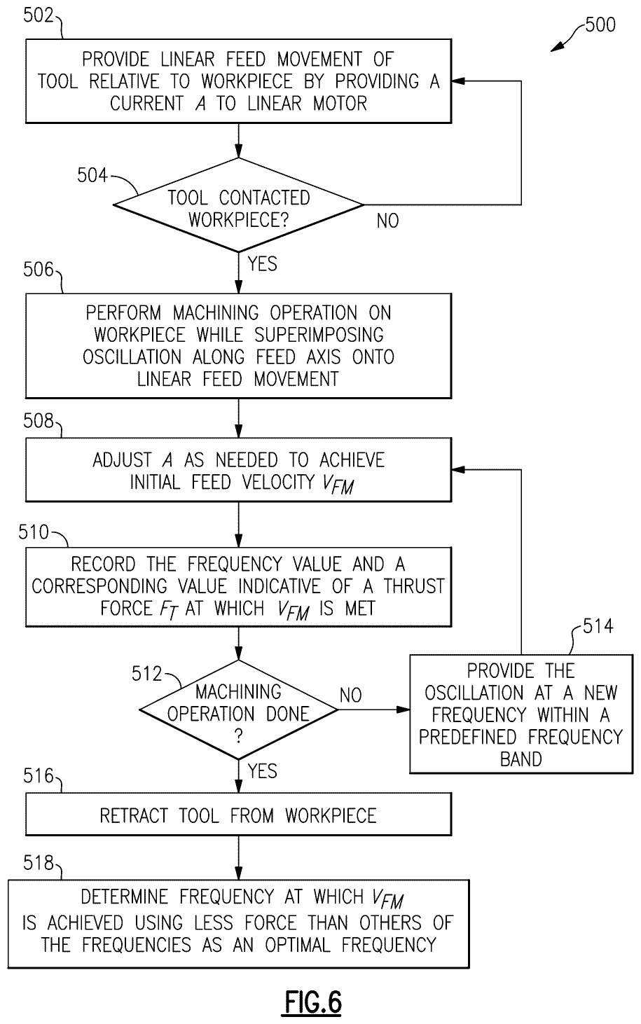

As used here, the “optimization mode” and “run mode” refer to operational modes of the controller 40 and not to a mode of vibration of the tool 22 or workpiece W. The optimization mode will now be described in greater detail in connection with FIG. 6.

FIG. 6 is a flowchart 500 of an example of the optimization mode. Linear feed movement of the tool 22 relative to the workpiece W is provided by providing a current to linear stator 60 of the linear motor 30 (step 502). Rotation of the tool 22 relative to the workpiece W and/or superimposing oscillation onto the feed movement of the tool 22 can also be initiated at this time, or that can be postponed until the tool 22 contacts the workpiece W.

The controller 40 monitors to determine if the tool 22 has contacted the workpiece (step 504). One way that the controller 40 can detect workpiece W contact is by an increase in the current needed by the linear motor 30 to maintain a feed velocity used in step 502, because that current is representative of a thrust force applied by the linear motor 30. Another way that the controller 40 could determine contact is by utilizing a force sensor. A force sensor could be mounted internally or externally along on the shaft 134, either on the rotating portion 34B, 134B or the non-rotating portion 34A, 134A. As another example, a force sensor could be mounted to the workpiece W (e.g., with the workpiece W situated between the machining device 20/120 and the force sensor).

Upon detecting contact (a “yes” to step 504), the machining operation is performed on the workpiece while superimposing oscillation onto the feed axis onto the linear feed movement of the tool 22 and providing rotation of the tool 22 relative to the workpiece W (e.g., by rotary motor 32) (step 506). During the machining operation, the feed movement is provided at a feed velocity V_{FM}.

The feed velocity V_{FM} is a velocity setpoint used by the controller 40 in a closed loop control algorithm. The controller 40 adjusts the current applied to the linear motor 30 as needed to achieve the desired linear movement feed velocity V_{FM} (step 508). If the desired feed velocity for machining V_{FM} is also used in step 502, the controller 40 will have to increase the current value provided to the linear motor 30 in order to maintain that feed velocity V_{FM} once the tool 22 contacts the workpiece W.

The controller 40 records a frequency value and corresponding value indicative of a thrust force F_{T} at which the velocity setpoint V_{FM} is achieved (step 510). In one example, the controller 40 determines a thrust force applied by the tool 22 based on an amount of current applied to the linear stator 60 of the linear motor 30.

The controller 40 then initiates a frequency sweep within a first frequency band to sequentially superimpose the superimposed oscillation at a plurality of different frequencies (steps 512-514) until the machining operation is complete (a “yes” to step 512). As used herein, performing a frequency sweep involves utilizing a plurality of discrete frequencies within a frequency range with some interval between the frequencies. In one example, the frequency band used for the frequency sweep is 1-10,000 Hz. In a further example, the frequency band is 1-5,000 Hz. In a further example, the frequency band is 1-2,000 Hz.

The tool 22 is then retracted from the workpiece (step 516), and a frequency at which the velocity setpoint V_{FM} is achieved using less thrust force than others of the frequencies is determined to be an optimal oscillation frequency F_{O} (step 518). In one example, the frequency at which the velocity setpoint V_{FM} is achieved using the least thrust force is determined to be the optimal oscillation frequency F_{O}.

In one example, the tool 22 is rotated at an approximately constant rotational velocity V_{ROT} during the optimization mode, by using V_{ROT} as a rotational velocity setpoint and adjusting an amount of current applied to stator 70 of the rotatory motor 32 as necessary to achieve the V_{ROT}.

In one example, the frequency sweep is terminated prior to completion of the machining operation if the sweep is completed before the machining operation is completed.

FIG. 7 illustrates a graph 700 demonstrating performance of an example frequency sweep during a machining operation, as depicted in the loop involving step 514 of FIG. 6. A shown in FIG. 7, the frequency oscillation sweep is performed starting from a first frequency Fₘᵢₙ which is swept up to a maximum frequency Fₘₐₓ and is then swept down again to the first frequency Fₘᵢₙ.

FIG. 8 illustrates a graph 750 showing how the thrust force F_{T} applied by the tool 22 varies during the frequency sweep of FIG. 7 while performing the machining operation utilizing feed movement at the velocity V_{FM} and sequentially superimposing oscillation at a plurality of different oscillation frequencies. As shown in FIG. 8, the thrust force F_{T} drops significantly from value N within a frequency band bounded by frequencies F₁ and F₃, with a minimum thrust force being applied at frequency F₂. In one example, the controller 40 performs step 518 by determining the minimum force (e.g., force F₂) as the optimal oscillation frequency F_{O}. In another example, the controller performs step 518 by selecting a frequency within the frequency band F₁-F₃ as the optimal oscillation frequency F_{O}.

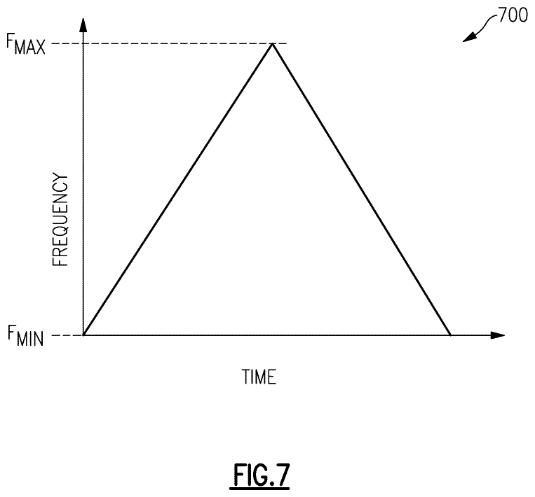

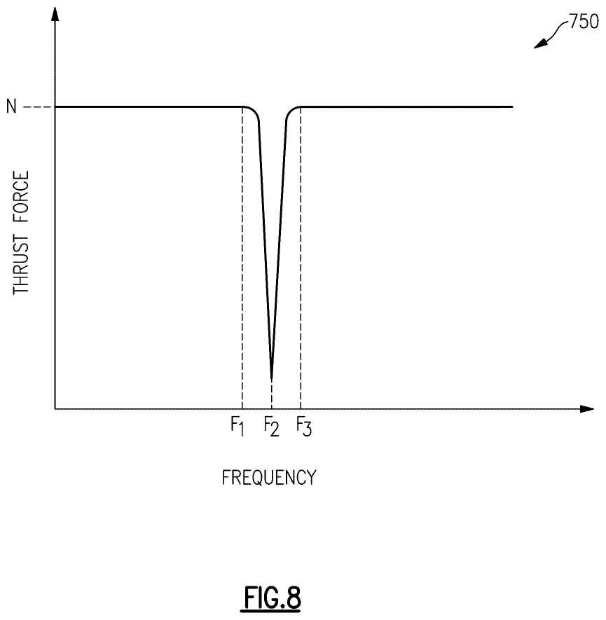

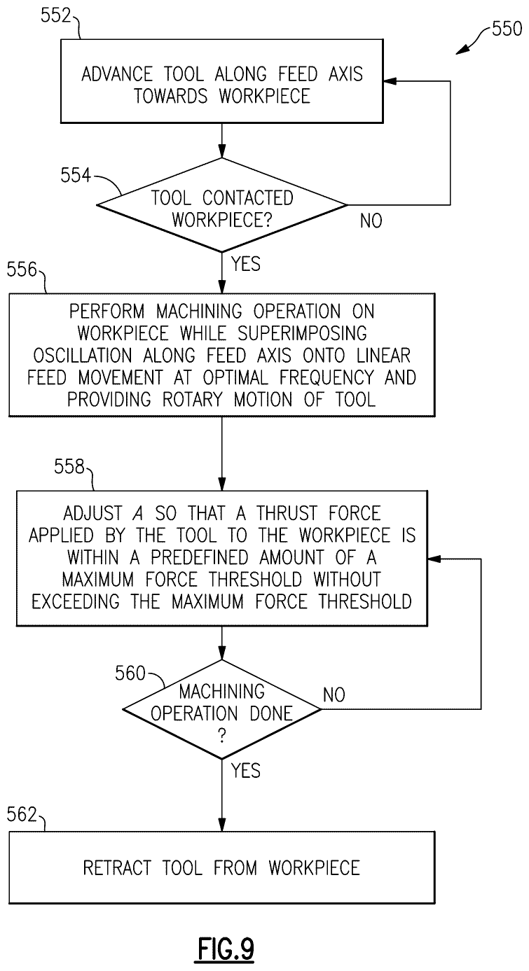

FIG. 9 is a flowchart 550 of an example method for performing a machining operation in the “run mode” and utilizing the optimal oscillation frequency F_{O} determined from the optimization mode of FIG. 6. The machining operation is performed on a second workpiece portion which can be part of the same or another workpiece utilized for the optimization mode of FIG. 6.

The tool 22 advances along the feed along the feed axis A1 towards the workpiece W (step 552). Once the tool 22 contacts the workpiece W (a “yes” to step 554), the machining operation is performed while superimposing oscillation onto the feed axis A1 onto linear feed movement at the optimal oscillation frequency F_{O} and providing rotation of the tool 22 relative to the workpiece W (e.g., by rotating the tool 22 or workpiece W) (step 556).

The controller 40 utilizes a force mode for the next step 558, during which the controller 40 utilizes the optimal oscillation frequency F_{O}, and adjusts a current A applied to the linear stator 60 of the linear motor 30 so that the thrust force F_{T} applied by the linear motor 30 is within a predefined amount of a maximum force threshold Fₘₐₓ without exceeding the force Fₘₐₓ. This could be within a predefined percentage of Fₘₐₓ (e.g., 2%, 3% 4%, 5%, or 10%) or it could be utilizing Fₘₐₓ itself.

In one example, the force mode causes the machining device 20/120 to utilize a run mode feed velocity V_{R} which is greater than the initial feed velocity V_{FM} used in the optimization mode of FIG. 6. This can be achieved because use of the optimal oscillation frequency F_{O} reduces the force that would otherwise be applied, balancing out the increase in thrust force provided by the increased feed velocity.

In one example, the force mode also has a maximum “do not exceed” velocity that the controller 40 is configured to avoid exceeding, which can be based on user preference.

Upon completion of the machining operation (a “yes” to step 560), the tool 22 is retracted from the workpiece (step 562).

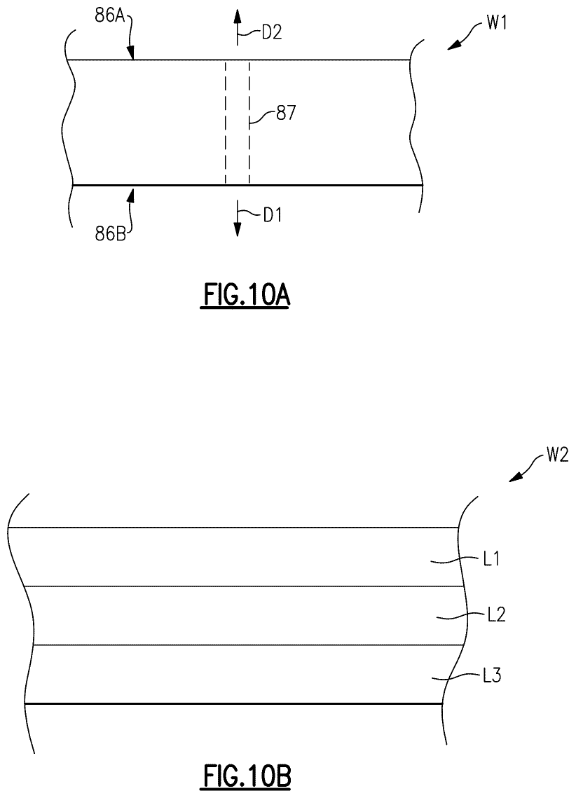

FIG. 10A illustrates an example single-layer workpiece W1 having a first side 86A and an opposing second side 86B. In one example, the machining operation performed by the machining device 20/120 is a drilling operation that drills a hole 87 from the first side 86A to the second side 86B of the workpiece W1 in a direction D1. In such an example, the controller 40 can determine that the tool 22 has advanced beyond the second side 86B based on a rate of change of a feed velocity applied by the tool 22 exceeding a predefined threshold. The increase in feed velocity occurs quickly when the tool 22 advances beyond the second side 86B because there is considerably less resistance to linear feed movement of the tool 22 after the tool 22 advances beyond the second side 86B. Although a hole is shown that passes through the workpiece W1, it is understood that blind holes could be drilled by the tool 22 additionally using displacement monitoring and control to ensure that the blind hole does not extend through the workpiece W (e.g., using sensor S1 or S2 associated with the linear motor 30).

As discussed above, the controller 40 superimposes oscillation onto linear feed movement of the tool 22 during a machining operation. In one example, the controller 40 also superimposes oscillation of the tool 22 onto the feed axis A1 during retraction of the tool 22 from a workpiece W in a direction D2 that is opposite the direction D1. Such oscillation during retraction can be beneficial for a variety of reasons. For drilling machining operations, as an example, oscillation during retraction can help minimize and/or remove burrs that would otherwise form on the second side 86B along a perimeter of the opening 87.

FIG. 10B illustrates another example workpiece W2 which includes a plurality of layers L1, L2, and L3 that have different compositions. One or more of the layers may be laminate layer, for example. In one example, the controller 40 determines an optimal oscillation frequencies for each of the layers L1-L3 during the optimization mode, and then subsequently during the run mode the controller 40 performs the machining operation on a portion of a workpiece that has the same composition by using the optimal oscillation frequencies determined during the optimization mode.

Some workpieces may have non-homogenous zones due to non-uniform physical properties, such as differing densities. In one example, the controller 40 includes an adaptive run mode for adjusting the optimal oscillation frequency for the non-homogenous zone of a workpiece.

FIG. 11 is a flowchart 600 of an example adaptive run mode for the machining device 20/120. The machining device 20/120 begins by performing a machining operation according to steps 552-560 described above. Upon detecting that the feed velocity decreases by more than a predefined percentage X % (a “yes” to step 604), the controller 40 detects that the tool 22 has encountered a non-homogenous zone of the workpiece W and adjusts its optimal oscillation frequency for machining the non-homogenous zone.

In one example, the adjustment involves superimposing different oscillation frequencies to see which provides for a reduced thrust force at a given feed velocity, as described in steps 508-514 of the method 500. This could include performing a frequency sweep, for example using a second frequency band. In one particular example, the second frequency band of the frequency sweep for the adaptive run mode is smaller than the first frequency band of the frequency sweep for the optimization mode (e.g., ±Y% of the optimal oscillation frequency for the homogenous portion of the workpiece).

Thus, based on the determination of step 606 that the tool 22 has encountered the non-homogenous zone, the controller 40 entering an adaptive run mode which includes sequentially superimposing the oscillating at a second plurality of different frequencies, and modifying the optimal oscillation frequency for at least the non-homogenous zone of the workpiece W to one of the second plurality of different frequencies that enables the tool to apply less thrust force to the non-homogenous zone at a given feed velocity than the unmodified optimal oscillation frequency (i.e., prior to the adjustment of step 606), enables the tool to travel at a higher feed velocity in the non-homogenous zone at a given thrust force than the un-modified optimal oscillation frequency, or both. In one example, the modified optimal oscillation frequency is the oscillation frequency that provides the least thrust force at a given feed velocity (and optionally a fixed rotational tool speed) to the workpiece within the second frequency band and/or that enables the highest feed velocity at a given thrust force level (and optionally at a fixed rotational tool speed) within the second frequency band.

Once the adjusted optimal oscillation frequency is determined, the controller 40 continues performing the machining operation according to steps 558-560 but using the adjusted optimal oscillation frequency (step 608).

Optionally, the controller 40 monitors (step 610) to see if the feed velocity increases by more than Z% which indicates that the tool 22 has exited the non-homogenous zone, and if the tool 22 has exited the non-homogenous zone the controller 40 resumes use of the previous optimal oscillation frequency (step 612). In one example, X% of step 604 and y% of step 610 are the same. Steps 610-612 are shown with a dotted outline to indicate that they are optional steps. If the tool 22 encounters a second non-homogenous zone, steps 604-608 could be repeated for that additional non-homogenous zone.

In one example, the controller 40 skips steps 610-612 and continues to use the modified optimal oscillation frequency for the rest of the machining operation, even if the tool 22 has exited the non-homogenous zone.

In a similar manner to how the controller 40 performs a frequency sweep to determine an optimal oscillation frequency while utilizing an approximately constant rotational velocity, the controller 40 could perform a sweep of tool 22 rotational velocities while utilizing a fixed oscillation frequency.

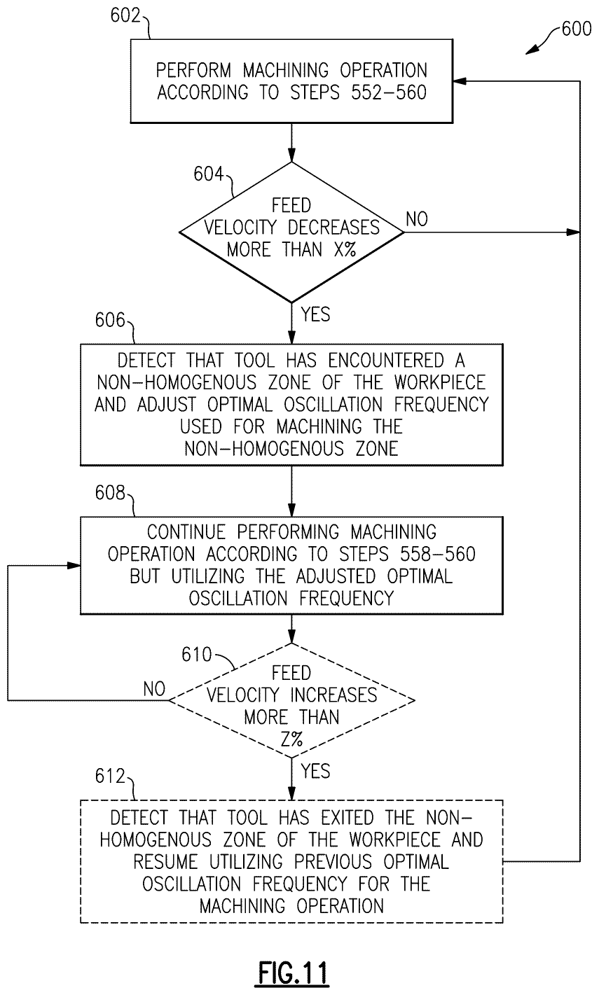

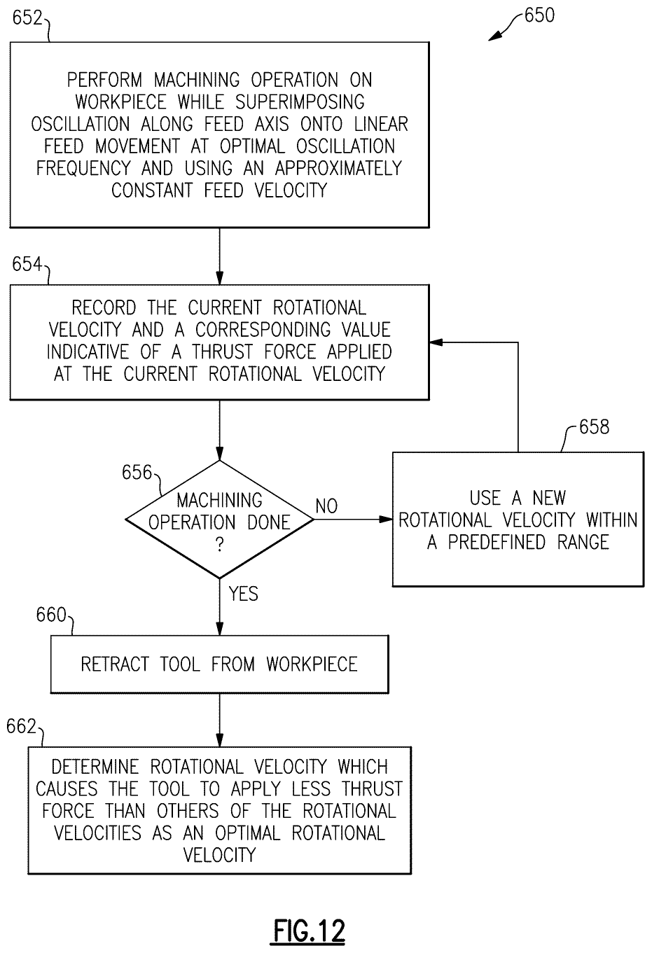

FIG. 12 is a flowchart 650 showing a method of determining an optimal rotational velocity. The controller 40 performs a machining operation on workpiece W while superimposing oscillation onto feed axis A1 onto linear feed movement of the tool 22 at the optimal oscillation frequency determined by method 500 for the workpiece and using an approximately constant feed velocity (step 652).

The controller 40 records the current rotational velocity and a corresponding value indicative of a torque applied by the rotary motor 32 at the current rotational velocity (step 654).

The controller 40 then utilizes a plurality of different rotational velocities within a predefined range and determines an associated thrust force F_{T} at each rotational velocity (the loop of steps 658-654). Once the machining operation is complete (a “yes” to step 656), the tool 22 is retracted from the workpiece W (step 660), and the controller determines a rotational velocity which causes the tool 22 to apply less thrust force F_{T} at the optimal oscillation frequency than others of the rotational velocities as an optimal rotational velocity (step 662). In one example, the rotational velocity at which the thrust force F_{T} is lowest is determined to be the optimal oscillation rotational velocity. If the optimal rotational velocity causes a lowered thrust force, this reduction can potentially be used to increase the feed velocity of the tool 22 while still avoiding exceeding a maximum force threshold.

The optimal rotational velocity can then be used at the optimal oscillation frequency for machining operations.

In one example, the determination of the optimal oscillation frequency (flowchart 500) and the determination of the optimal rotational velocity (flowchart 650) are iteratively performed by re-determining the optimal oscillation frequency at the optimal rotational velocity, and re-determining the optimal rotational velocity at a new optimal oscillation frequency. This iterative performance could further reduce a force applied to a workpiece by the tool 22.

In one example, the controller 40 stores optimal machining parameters in memory 44, such as optimal oscillation frequencies to be superimposed on to linear feed movement and/or optimal rotational velocities for a variety of materials. The user interface 46 of the controller 40 can be utilized by an operator to recall those optimal values so that the optimization mode can be performed once for a plurality of machining operations for workpieces having a given composition.

The machining device 20/120 discussed above provides a number of benefits, including providing linear feed movement and superimposing oscillation from a single linear motor 30. This provides for space reduction and, if desired, allows a positioning device to avoid moving the machining device 20/120 and/or avoid moving the workpiece W during certain machining operations. Prior art devices which provided for oscillation during machining did not do so from a single linear motor, but rather utilized separate devices for feed movement and oscillation. Also, those devices provided oscillation not through superimposing oscillation onto a DC control signal provided to a linear motor, but instead by using secondary devices such as piezo elements, hydraulics, or induction coils, which suffer from one of more of the following: being less precise than the machining device 20/120, being limited in range of motion compared to the machining device 20/120, utilizing more space than the machining device 20/120, being more costly than the machining device 20/120, and having limited resolution for closed loop feedback control compared to the machining device 20/120. The integrated multi-axis self-contained machining device 20/120 lends itself to portability as an end effector to a delivery device such as a robot for large workpieces (e.g., motor vehicles, aircraft, vessels, etc.).

Also, the techniques described herein for identifying optimal oscillation frequencies and rotational speeds provide for reducing thrust force and torque, which enables the use of increased feed velocities without exceeding maximum force thresholds, thereby reducing the time required for machining operations, improving tool life, and enhancing the desired machined feature geometry and/or integrity.

Although the methods described in flowcharts 500, 550, 600, and 650 have been described in connection with the machining device 20/120 which utilizes a single linear motor 30/130 to provide for both linear feed movement and the superimposing of oscillation onto the linear feed movement, it is understood that the methods could also be used to control machining devices that utilize separate devices to provide for feed movement and oscillation (e.g., a linear motor for feed movement and a piezoelectric or electroacoustic device to provide oscillation) and/or that use techniques such as hydraulics, piezo elements, and/or electroacoustic transducers to provide for vibration.

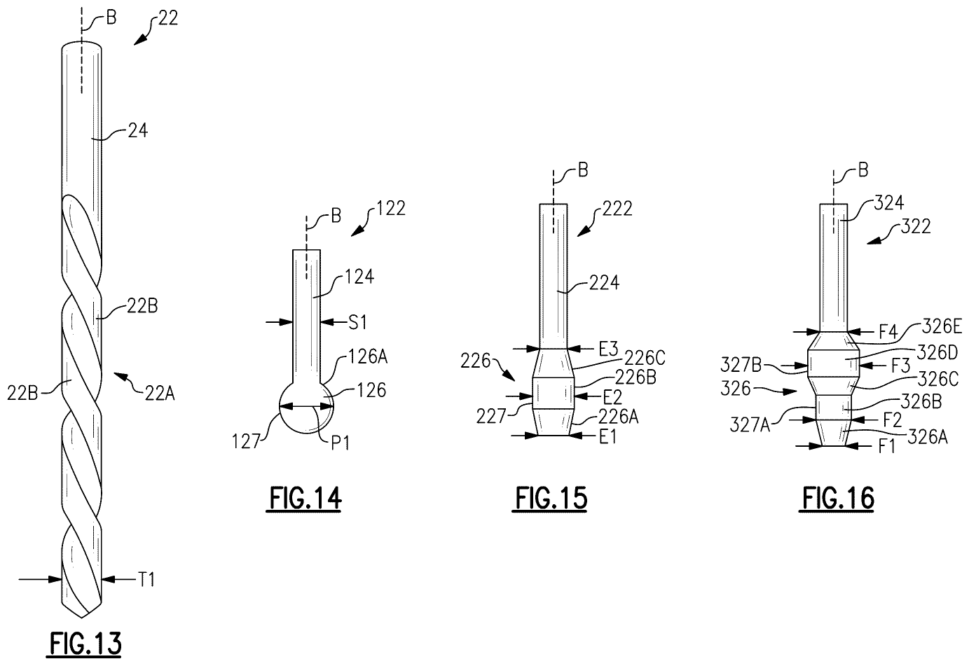

FIG. 13 illustrates the example tool 22 that may be used with, or separately from, the method and/or machining device 20 described above to make a hole 87 in a workpiece W2 as shown in FIG. 17. In the illustrated example, the tool 22 is a traditional carbide twist drill bit that has a cylindrical shaft 24 defining a bit axis B (coaxial with longitudinal axis A1) and a drill working section 22A that includes spiral flutes 22B. The tool 22 is used in connection with any of the methods described above to form the hole 87 with a diameter H1. It is to be appreciated that the tool 22 is not limited to a twist bit and may alternatively be another style of bit. In further examples, the tool 22 includes other profiles to perform machining operations other than forming a hole. The diameter H1 of the hole 87 shown in FIG. 17 corresponds to a diameter T1 of the tool (bit) 22 shown in FIG. 13.

FIG. 14 illustrates another tool 122 for treatment of the material surrounding the hole 87 that can be used with any of the methods 500, 550, 600, and 650 described above. In the illustrated example, the tool 122 work hardens, or strain hardens the workpiece W2 with compressive residual strain, such as through a peening, burnishing, swaging, and/or another type of work hardening, to improve the material properties.

The illustrated a stress strain curve of FIG. 22 of FIG. 2 includes four quadrants (Q1-Q4). The stress-strain curve of FIG. 22 is for illustrative purposes as each specific material could have a variations in the stress-strain curve based on individual material properties. The second quadrant Q2 illustrates an increased yield strength Y1 in a hoop direction of the hole with the tool 122 and a residual hoop tensile strain increase shown by line RH. The fourth quadrant Q4 illustrates an increased yield strength Y2 in a radial direction of the hole after treatment with the tool 122 and an increase in residual radial compressive strain RR. One feature of the above identified material characteristic changes is that by first inducing a permanent, or plastic compressive residual strain in a part that experiences tensile strain in application use, the part could have a significant reduction in those tension strains thus increasing the fatigue life and mitigating crack propagation especially but not limited to between closely located holes. See FIG. 22.

In the illustrated example, the tool 122 includes an elongated cylindrical shaft 124 with flat surfaces (not shown) adjacent a first, proximal end (top) to facilitate connection to the machining device 20, such as through a chuck. A ball or spherically shaped work-hardening section 126 is located at a second, distal end of the shaft 124 (bottom). In this example, the spherically shaped work-hardening section 126 is a solid, domed body (e.g., not hollow) that defines a smooth (non-abrading, non-cutting) working surface 127 over its axial length. For example, the surface 127 is smoother than an as-machined surface and excludes any flutes, steps, or the like that remove material from the workpiece. The spherically shaped work-hardening section 126 has a diameter P1 that is greater than a diameter S1 of the shaft 124. In the axial direction of the shaft 124, the dome formed by the work-hardening section 126 also extends for more than 180 degrees to create a curved ledge portion 126A that faces the shaft 124. The diameter P1 of the tool 122 is also greater than the diameter H1 of the hole 87. Therefore, the work-hardening section 126 will not fit into the hole 87 without deforming the workpiece. The work-hardening section 126 and shaft 124 are formed as a monolithic structure from a single piece of material, such as a carbide, which facilitates increased strength, but in an additional example the tool 122 is formed from a separate shaft and ball that are joined, such as through a welding process.

Similar to the tool 22, machining device 20 oscillates and/or rotates the tool 122 along the feed axis A1 as described above with respect to the tool 22. In one example, the machining device 20 operates with the tool 122 in the optimization mode with steps 502-518 of the method 500. The method 500 determines for the tool 122 a frequency at which a velocity setpoint V_{FM} for the tool 122 is achieved using less thrust force than others of the frequencies to be an optimal oscillation frequency F_{O} (step 518). In one example, the frequency at which the velocity setpoint V_{FM} is achieved using the least thrust force is determined to be the optimal oscillation frequency F_{O}. Alternatively, the machining device 20 operates the tool 122 under the same velocity setpoint V_{FM} and optimal oscillation frequency F_{O} determined for the tool 22.

When the tool 122 is used in connection with the methods 500, 550, and 650, steps 516, 562, and 660, respectively, include at least one of rotating or superimposing oscillations along the feed axis during retraction of the tool 122. One feature of rotating or superimposing oscillations along the feed axis on the tool 122 during retraction is the removal of burs from around a perimeter of the hole 87 on an opposite side of the workpiece W2 from where the tool 122 was inserted. By using the tool 122 to remove burs, additional deburring steps are eliminated which reduces the time and/or cost to produce a desired part from the workpiece W2. Furthermore, the tool 122 can provide additional work hardening to the workpiece W2 while it is being retracted to develop additional favorable material properties.

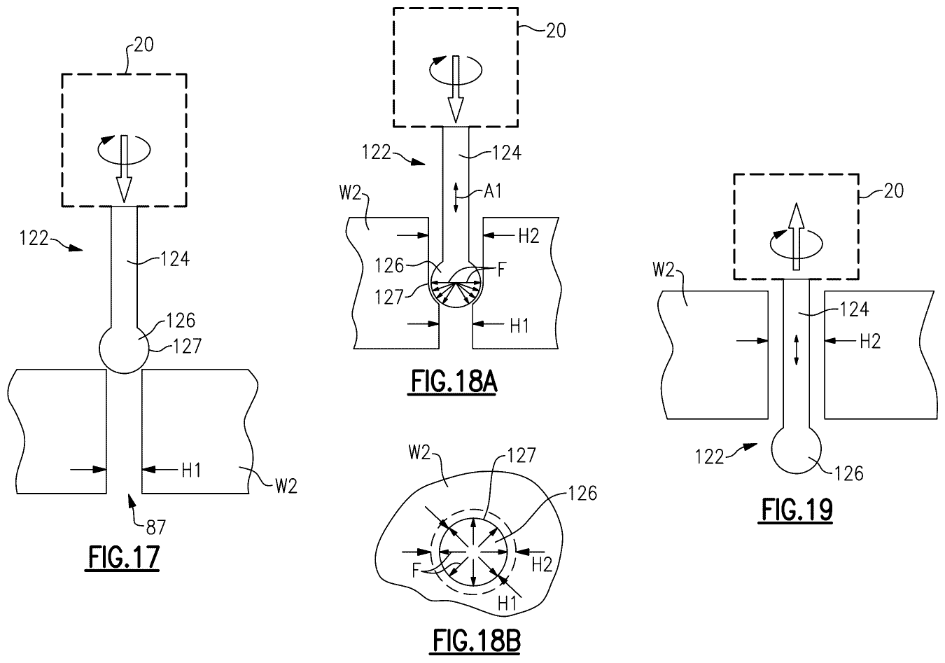

FIGS. 17-19 illustrate the tool 122 being used in connection with the optimization modes of the methods 500 and 650 or the run mode of the method 550. After the tool 122 is brought into contact with the workpiece W2 in steps 504, 554, the machining operation is performed in steps 506 and 556 with the tool 122. While the machining operation is being performed, the linear feed movement and/or oscillations cause the generation of the peening-burnishing forces against the workpiece W2 as shown by the arrows F in FIGS. 18A and 18B. In the illustrated example, the arrows extend from a center of the work-hardening section 126 towards an exterior surface of the work-hardening section 126 such that arrows F are perpendicular to the exterior surface of the work-hardening section 126.

As shown in FIGS. 18A and 18B, work-hardening section 126 expands the diameter H1 of the hole 87 to approximately the diameter P1 of the work-hardening section 126. However, depending on the type of material of the workpiece W2 and a difference in the diameter H1 with the diameter P1, a diameter H2 of the hole 87 after machining with the tool 122 can be less than or equal to the diameter P1. In cases where the diameter H2 is less than P1, the retraction of the tool 122 in steps 516, 562, and 660 can further work harden the workpiece W2 such that the machined diameter of the hole 87 is closer to the diameter P1 than it was with only a single pass through the hole 87.

FIG. 15 illustrates another example tool 222 for work hardening a workpiece W. The tool 222 includes a shaft 224 with an work-hardening section 226 having a frustoconical distal end portion 226A, a cylindrical intermediate portion 226B that defines a working surface 227, and a frustoconical proximal end portion 226C. The frustoconical distal end portion 226A includes a distal end having a diameter E1 and a proximal end having a diameter E2. The diameter E1 is less than the diameter H1 of the hole 87 to assist in aligning the tool 222 with the hole 87. Alternatively, the diameter E1 could be larger than the diameter H1.

In the illustrated example, the intermediate portion 226B is cylindrical and has a constant diameter E2 over its length. In another example, the diameter of the intermediate portion 226B includes a partial elliptical or partial spherical cross-section such that a diameter varies over the length. The intermediate portion 226B includes the largest diameter on the tool 222 that extends through the hole 87 and will experience the work hardening forces F in addition to the distal end portion 226A when the tool 22 is being inserted in the hole 87.

In the illustrated example, the frustoconical proximal end portion 226C includes a distal end with a diameter that matches the adjacent portion of the intermediate portion 226B and tapers towards the shaft 224 in a proximal direction to a diameter E3. The diameter E3 may match the diameter E1 or it may be different. In the illustrated example, the frustoconical proximal end portion 226C is a mirror image of the frustoconical distal end portion 226A. For instance, the axial lengths, diameters, and slopes of the portions 226A/226C are identical. In another example, the frustoconical proximal end portion 226C and the frustoconical distal end portion 226A are non-mirror images. For example, the axial lengths, diameters, and/or slopes differ. In yet another example, the end portion 226 is bilaterally symmetrical about an axis through the intermediate portion 226B perpendicular to the axis of the shaft 224. The machining device 20 will operate with the tool 222 in a similar manner as described above with respect to the tool 122 for the disclosed methods 500, 550, and 650.

FIG. 16 illustrates another example tool 322 for work hardening an area surrounding the hole 87 in the workpiece W. The tool 322 includes a work-hardening section 326 distal of a shaft 324. The work-hardening section 326 includes a distal end frustoconical portion 326A, a distal intermediate cylindrical portion 326B that has a working surface 327A, an intermediate frustoconical portion 326C, a proximal intermediate cylindrical portion 326D that has a second working surface 327B, and a frustoconical proximal end portion 326E. The distal end frustoconical portion 326A includes a distal end having a diameter F1 and a proximal end having a diameter F2. The diameter F1 is less than the diameter H1 of the workpiece to assist in aligning the tool 222 with the hole 87. Alternatively, the diameter F1 could be larger than the diameter H1.

In the illustrated example, the distal intermediate cylindrical portion 326B has a constant diameter F2. In another example, a diameter of the intermediate portion 326B could have a partial elliptical or spherical cross-section with a varying diameter. The distal intermediate cylindrical portion 326B connects the distal end frustoconical portion 326A with the intermediate frustoconical portion 326C. The intermediate frustoconical portion 326C transitions from the diameter F2 at the distal intermediate portion 326B to a diameter F3 at the proximal intermediate portion 326D. For instance, in the illustrated example the diameter F3 is greater than the diameter F2. This provides a progressive working hardening process. The proximal intermediate cylindrical portion 326D includes the largest diameter on the tool 322 at F3.

The frustoconical proximal end portion 326E includes a distal end that matches the adjacent portion of the proximal intermediate portion 326D and tapers towards the shaft 324 at a proximal end of the portion 326E to a diameter F4. The machining device 20 will operate with the tool 322 in a similar manner as described above with respect to the tool 122 for the disclosed methods 500, 550, and 650.

FIG. 20 illustrates another example tool 422 for use with the machining device 20. The tool 422 includes a drill working section 422A adjacent a distal end and a frustospherical (portion of a sphere) work-hardening section 426 with a working surface 427 separating the drill bit portion 411A from a shaft 424 for attaching to the machining device 20. In this example, the portion of the sphere extends less than 180 degrees, such as 90 degrees or less. The drill working section 422A functions as the tool 22 shown in FIG. 13 for forming a hole 87 in the workpiece W. However, the tool 422 also includes the work-hardening section 426 that functions similarly to the tool 122 to expand and work harden the material surrounding the hole 87.

The work-hardening section 426 includes a diameter T2 at a distal end and a diameter S1 at a proximal end that matchers a diameter of the shaft 424. In the illustrated example, the diameter T2 is less than or equal to the diameter T1 and the diameter S1 is greater than the diameter T1. In the illustrated, the work-hardening section 426 has a partial spherical profile or cross-section (frustrum of a sphere). In another example, the section 426 has a frustoconical profile or cross-section.

Operation of the method 500 with the tool 422 follows the procedure outlined above except where described below. In particular, step 512 continues at a frequency within the predefined frequency band until the work-hardening section 426 has passed entirely through the hole 87 in the workpiece W2. The oscillation frequency can also vary while the work-hardening section 426 is in the hole 87 to determine an optimal frequency for the work-hardening section 426. Therefore, the machining device 20 may assign different optimal frequencies for the drill working section 422A and the work-hardening section 426 when performing the run mode of the method 550 with the tool 522.

Similarly, operation of the method 650 with the tool 422 follows the procedure outlined above except where described below. In particular, step 656 continues at a rotational speed within the predefined range until the work-hardening section 426 has passed entirely through the hole 87 in the workpiece W2. The rotational speed can also vary while the work-hardening section 426 is in the hole 87 to determine an optimal rotational speed for the work-hardening section 426 in additional to the drill working section 422A. Therefore, the machining device 20 may assign different optimal rotational speeds for the drill working section 422A and the work-hardening section 426 when performing the run mode of the method 550 with the tool 522.

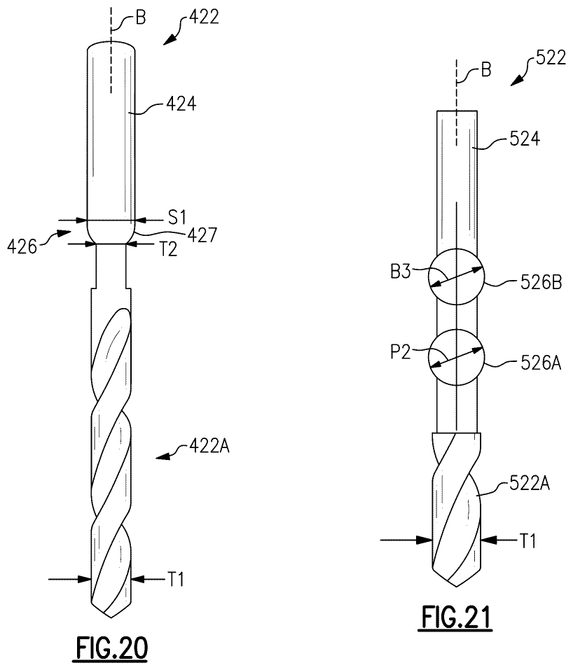

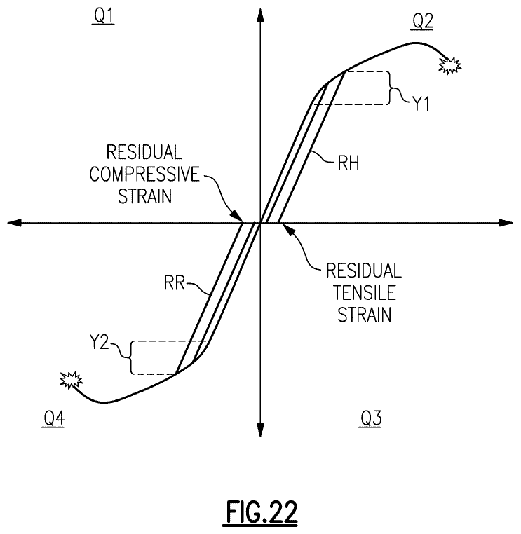

FIG. 21 illustrates yet another example tool 522 for use with the machining device 20. The tool 522 includes a drill working section 522A adjacent a distal end, a distal work-hardening section 526A, a proximal work-hardening section 526B, and a shaft 524 for attaching to the machining device 20. The drill working section 522A functions as with the tool 22 shown in FIG. 13 for forming the hole 87 in the workpiece W2. However, the tool 522 also includes multiple work-hardening sections 526A/526B that function similarly to the tool 122 to expand and work harden the material surrounding the hole 87.

The distal work-hardening section 526A is frustospherical (partially spherical) with a diameter P2 that is greater than a diameter T1 of the drill working section 522A. The proximal work-hardening section 526B is also frustospherical and includes a diameter P3 that is greater than both the diameter T1 and the diameter P2 on the tool 522. The difference in the diameters P2 and P3 provides a progressive working hardening process similar to the tool 322 due to the different diameters of the distal and proximal work-hardening section 326 (326B and 326D).

Operation of the method 500 with the tool 522 follows the procedure outlined above except where described below. In particular, step 512 continues at a frequency within the predefined frequency band until the work-hardening sections 526A/526B have both passed entirely through the hole 87 in the workpiece W2. The oscillation frequency can also vary while the work-hardening sections 526A/526B are in the hole 87 to determine an optimal frequency for the work-hardening sections 526A/526B. Therefore, the machining device 20 may assign different optimal frequencies for the drill working section 522A and the work-hardening sections 526A/526B when performing the run mode of the method 550 with the tool 522.

Additionally, during steps 516 and 562 of the methods 500 and 550, respectively, the machining device 20 can oscillate the tool 522 at a frequency within the predefined frequency band or at an optimal frequency at least while the proximal work-hardening sections 526B is being retracted.

Similarly, operation of the method 650 with the tool 522 follows the procedure outlined above except where described below. In particular, the step 656 continues at a rotational speed within the predefined range until both the work-hardening sections 526A/526B have passed entirely through the hole 87 in the workpiece W2. The rotational speed can also vary while the work-hardening sections 526A/526B are in the hole 87 to determine an optimal rotational speed for each of the work-hardening sections 526A/526B in additional to the drill bit portion 522A. Therefore, the machining device 20 may assign different optimal rotational speeds for the drill working section 522A and the work-hardening sections 526A/526B when performing the run mode of the method 550 with the tool 522.

Although example embodiments have been disclosed, a worker of ordinary skill in this art would recognize that certain modifications would come within the scope of this disclosure. For that reason, the following claims should be studied to determine the scope and content of this disclosure.

What is claimed is:

1. A tool bit comprising:
a shaft defining a bit axis and having a first end and a second end; and
at least one work-hardening section adjacent the second end, the at least one work-hardening section having a profile that either is cylindrical or is a portion of a sphere, the at least one work-hardening section defining a smooth working surface.

2. The tool bit as recited in claim 1, wherein the profile is cylindrical.

3. The tool bit as recited in claim 1, wherein the profile is the portion of the sphere.

4. The tool bit as recited in claim 3, wherein the portion of the sphere extends for more than 180 degrees.

5. The tool bit as recited in claim 1, wherein the at least one work-hardening section further comprises first and second frustoconical sections that are oppositely oriented from each other.

6. The tool bit as recited in claim 5, wherein the first and second frustoconical sections are symmetric.

7. The tool bit as recited in claim 1, wherein the shaft defines a first diameter, and the at least one work-hardening-section defines a second diameter that is greater than the first diameter.

8. The tool bit as recited in claim 1, wherein at least one work-hardening section includes, relative to the first end, a first, distal work-hardening section and second, proximal work-hardening section that are both cylindrical.

9. The tool bit as recited in claim 8, wherein the first work-hardening section defines a first diameter and the second work-hardening section defines a second diameter that is greater than the first diameter.

10. The tool bit as recited in claim 1, wherein at least one work-hardening section includes, relative to the first end, a first, distal work-hardening section and second, proximal work-hardening section that are both portions of a sphere.

11. The tool bit as recited in claim 10, wherein the first work-hardening section defines a first diameter and the second work-hardening section defines a second diameter that is greater than the first diameter.

12. A machining device comprising:
a tool;
a linear motor comprising a core and stator that each surround a longitudinal feed axis, the linear motor operable to provide linear movement of the tool relative to the stator along the longitudinal feed axis, and superimpose oscillation of the tool onto the feed axis during the linear movement;
a rotary motor operable to rotate the tool about the longitudinal feed axis during the linear movement; and
a controller operable to cause the linear motor to provide the linear movement and superimpose the oscillation by oscillating a direct current (DC) control signal provided to the linear motor;
the tool comprising
a shaft defining a bit axis and having a first end and a second end, and
a work-hardening section adjacent the second end, the work-hardening section having a profile that either is cylindrical or is a portion of a sphere, the work-hardening section defining a smooth working surface.

13. The machining device as recited in claim 12, wherein the profile is cylindrical.

14. The machining device as recited in claim 12, wherein the profile is the portion of the sphere.

15. A method comprising:
oscillating a direct current (DC) control signal provided to a linear motor, and thereby causing the linear motor to provide linear movement of a tool along a feed axis relative to a workpiece and to oscillate the tool during the feed movement, such that the oscillation is superimposed onto the linear movement; and
rotating the tool about the feed axis during the linear movement, as part of a machining operation,
the tool comprising
a shaft defining a bit axis and having a first end and a second end, and
a work-hardening section adjacent the second end, the work-hardening section having a profile that either is cylindrical or is a portion of a sphere, the work-hardening section defining a smooth working surface.
